(19) United States
(12) Patent Application Publication
(10) Pub. No.: US 2023/0100561 A1
(43) Pub. Date: Mar. 30, 2023

(54) SAFETY CONNECT SYSTEM FOR ASSURING FAIL SAFE OPERATION OF AN ENERGY SOURCING SYSTEM

(71) Applicant: WMK SAFETY SOLUTIONS, LLC, Louisville, TX (US)

(72) Inventors: Robert W. Wright, JR., Louisville, KY (US); Michael D. Robertson, Burnet, TX (US)

(21) Appl. No.: 18/075,134

(22) Filed: Dec. 5, 2022

Related U.S. Application Data
(63) Continuation of application No. 17/961,086, filed on Oct. 6, 2022.
Application No. 17/961,086 is a continuation of application No. 16/026,425, filed on Jul. 3, 2018, now abandoned.

(51) Int. Cl. B60L 53/63; H02H 5/10; H02J 7/00; B60L 53/14; B60L 53/31

(52) U.S. Cl. CPC B60L 53/63; H02H 5/10; H02J 7/0031; B60L 53/14; B60L 53/31

(57) ABSTRACT

A safety connect system and a method for assuring fail safe operation of an energy sourcing system are disclosed. The energy sourcing system is used to recharge batteries in electric vehicles (EVs). The energy sourcing system includes an electrical energy source connected to an enclosure. The enclosure sources energy from said electrical energy source and supplies to an energy consuming device. The enclosure detects a change in position of the enclosure when it goes above a preset threshold or when there is a malfunction. The enclosure sends a safety signal to the electrical energy source when no malfunction or change in position is detected. When the enclosure does not send the safety signal, the electrical energy source does not allow the energy to flow to the enclosure.

### RELATED APPLICATIONS AND CLAIM FOR PRIORITY

The present application is a continuation-in-part (CIP) application of U.S. patent application Ser. No. 17/961,086 filed Oct. 6, 2022, and titled “Safety Disconnect System” with Attorney Docket No. WMKS001US1; which is a continuation of U.S. patent application Ser. No. 16/026,425 filed Jul. 3, 2018, and titled “Safety Disconnect System” with Attorney Docket No. WMKS001US0; all of which are incorporated herein by their entirety and referenced thereto.

### FIELD OF INVENTION

The present invention relates to the field of automotive Electric Vehicle (EV) charging stations. More particularly, the present invention relates to safety circuits or devices that connect electrical power feed to an Electric Vehicle (EV) charging station only when there are no measurements of damage or malfunctions in any way to the EV charging station.

### BACKGROUND OF INVENTION

It is known that plugin electric vehicles offer better fuel economy, lower emissions, and good acceleration. Automotive manufacturers are constantly introducing electric vehicles to the consumer market. At least one industry forecast predicts up to 400,000 battery powered electric vehicles in North America in the year 2020 and every year thereafter with up to 7 million by the year 2025.

The electric vehicles depend on (electric) chargers to supply a connection to the grid for drivers on the go. The chargers provide a direct charge of electricity needed to recharge a battery of the electric vehicles. The chargers are placed at a charging station. The charging station includes an energy source that is remotely located from the free-standing charging station enclosure that requires charge.

The charging stations for the electric vehicles are equivalent to gasoline and diesel pumps at filling stations as both supply energy to vehicles (gasoline/diesel to power vehicles operating on Internal Combustion (IC) engines, and chargers for powering the battery of the electric vehicle). Fuel pumps are usually guarded with heavy duty posts called bollards, typically painted bright yellow for high visibility and are located at each of the four corners of the fuel service islands and usually close to the pumps. The posts are generally at least four inches in diameter and are generally steel pipes that may be concrete filled or are constructed of steel reinforced concrete. The posts extend down into the foundation for increased strength. The purpose of the bollards is to prevent an out-of-control vehicle from striking a fuel pump and partially or totally dislodging the pump and cabinet from the foundation, at which point an explosion may occur due to the presence of leaking fuel and possible sparking of electrical wires.

Furthermore, electrical wiring may be exposed and cause severe or lethal shocks to anyone in the adjacent area. However, bollards typically don't cover the entire area around the fuel pumps, and an out-of-control vehicle approaching from a given angle is capable of dislodging a pump and causing the dangerous situation described above. Further, the bollards are sometimes installed incorrectly or may have been knocked loose and cannot provide protection as originally intended.

With the advent of electrical and hybrid vehicles, EV (electrical vehicle) charging stations are appearing in many locations throughout the world. Many of the charging stations are similarly protected by the bollards, but many are not. As stated above, the bollards don't totally prevent the vehicle from dislodging the charging station from the foundation. Obviously, such charging stations have high voltage wiring within the enclosure, generally entering from underground conduits within the foundation and going on up into the enclosure. The EV (electric vehicle) charging stations pose a possibly more serious electrical hazard than do common fuel pumps. Consequently, a serious danger is present when the charging station enclosure is dislodged and high voltage wiring is exposed.

There is a possibility of damage to the electric vehicle charging station or other high voltage systems due to a collision or being struck with force sufficient to cause component failure, physical damage, systemic damage, or physical displacement; damaging high winds resulting from natural occurrences such as a hurricane, tornado, etc.; high water or flooding events; excessive/violent/sustained physical motion/movement/shaking such as an earthquake; and/or physical damage resulting from vandalism or terroristic act.

The damage may be sufficient to cause the charging station enclosure, pole/post, or supporting structure to become completely dislodged from its foundation, mount, or supporting system; become partially dislodged from its foundation, mount, or supporting system; sustain physical damage; sustain damage to the components contained/housed/enclosed/supported; and/or overheat causing damage to the components contained/housed/enclosed/supported thereby.

Moreover, exposure to the dangerously high voltage power feed and its' conductors, terminals, or wiring causing physical contact with conductive metals, liquids, or a person/animal creates the possibility for shock or electrocution and fire or explosion. Exposure of the dangerously high voltage power feed cabling, conductors, terminals, or wiring causing electrification by proximity to conductive metals, liquids, or person/animal could also create the possibility for shock or electrocution and fire or explosion.

In the event the EV (electric vehicle) charging station is exposed to a substantial enough force to move the charging station from its originally mounted position or wiring to the charging station should become exposed, a safety system should be in place to disconnect the incoming power at its source. Safety circuits that disconnect the incoming power in the event of a ground fault or in the event of a current overload are common in fuel pumping stations and EV charging stations found in the marketplace. A ground fault or over current circuit might disconnect the incoming power to a dislodged station if the dislodging resulted in a ground fault or an over current situation, but it is possible that the underground conduit may be broken and wiring exposed without creating a ground fault or an over current situation.

Several solutions have been proposed in the past. One such example is disclosed in a United States granted U.S. Pat. No. 9,368,959, entitled “Displacement safety system for electrical charging stations” (“the '959 Patent”). The '959 Patent discloses sending a signal that shuts down the power if a fault is detected. The main problem in the related art is that if the damage occurs such that all the wires delivering energy to the sourcing enclosure are cut, then there will be no energy available to send the signal to cause the source of electrical energy to shut down as the wire delivering that shut down signal would most likely be also cut.

Therefore, there is a need in the art to provide a much safer alternative of not sending a signal if a fault is detected, and shutting down the energy if the signal is not present.

### SUMMARY

It is an object of the present invention to provide safety circuits or devices that do not connect and if energized, electrical power feed to an EV Charge enclosure or fuel pump enclosure, disconnects when said enclosure gets damaged or malfunctions in any way, thus avoiding the drawbacks of known techniques.

It is another object of the present invention to provide a safety circuit that does not connect and if energized, disconnects incoming power when the energy sourcing enclosure or wiring has become dislodged or damaged, to remove the chance of electrical shocks or electrocution of bystanders who are unaware of such dangers.

It is yet another object of the present invention to provide a safety circuit that may be added to the normal circuitry within an electric vehicle charging station or a fuel pumping station which automatically removes electric power from the source of electric power as a result of damage or any malfunction, thus removing dangerous high voltage which may be exposed by such malfunction.

In order to achieve one or more objects here stated, the present invention provides an energy sourcing system having an electrical energy source connected to a Motion/Shock Detection Device. The Motion/Shock Detection Device sources energy from the electrical energy source and supplies to an energy consuming device. The Motion/Shock Detection Device includes a control circuit board. The control circuit board includes a motion detection and shock sensor. The motion detection sensor detects a change in position of the Motion/Shock Detection Device. The control circuit board repeatedly sends a safety signal to the electrical energy source when the motion detection sensor detects the change in position of the Motion/Shock Detection Device is below a preset threshold. The electrical energy source does not allow the energy to flow to the EV Charger enclosure when the electrical energy source does not receive the safety signal from the Motion/Shock Detection Device.

In one implementation, the Motion/Shock Detection Device sends a safety signal to the electrical energy source when no malfunction is detected and the EV Charger sends a request for power. The electrical energy source supplies a high frequency low voltage signal to the Motion/Shock Detection Device by means of PLC (Power Line Communication). Here, when the Motion/Shock Detection Device does not send the safety signal to the electrical energy source, then the electrical energy source supplies a lower frequency, low voltage signal to the Motion/Shock Detection Device to provide operational energy for the Motion/Shock Detection Device.

The Motion/Shock Detection Device includes a controller. The controller resets or shuts down the electrical energy source when motion detection sensor detects the change in position of the Motion/Shock Detection Device exceeds the threshold. The Motion/Shock Detection Device resets or shuts down the electrical energy source by stopping the safety signal sent to the electrical energy source.

The Motion/Shock Detection Device includes a communication device such as a Bluetooth device for transmitting information corresponding to the malfunction or the safety signal.

In the present invention, the enclosure includes an electric vehicle (EV) charger and a movement/shock detection device. The EV charger is separate from the movement/shock detection device. The Movement/shock detection device connects to the exterior of the EV charger (e.g., at an EV charger cabinet (not shown)). Optionally, the Movement/Shock Detection Device is integrated in the EV charger. The Movement/Shock Detection Device includes a Movement Shock Detection Sensor. The Movement/Shock Detection Sensor has selectable preset detection levels that can detect movement or acceleration in any of 3 axis (X, Y, Z) and removes an enable when the preset level is exceeded. The operation of Movement/Shock Detection Sensor is enabled by a Request for Power from the EV Charger. Upon receiving a Request for Power, the Movement/Shock Detection Device applies a (110 kHz) tone to the AC Power Line by means of a PLC (Power Line Communication) Circuit. The PLC capacitively couples the tone onto the AC Power Line. Further, the AC Power Line connects the EV Charger to the Electric Vehicle Power Panel (EV PWR PNL) which is located remotely from the EV Charger. The EV PWR PNL includes a power line communication (PLC) circuit that feeds a Tone Detection Device. The Tone Detection Device receives a 110 kHz tone from the PLC and enables a drive to a Contactor Switch that connects grid AC Source to the AC Power Line that feeds the EV Charger.

In one advantageous feature of the present invention, the electrical vehicle charging system or the energy sourcing system comprises the Motion/Shock Detection Device with associated means for sourcing energy to an electric vehicle. The Motion/Shock Detection Device is fixedly secured to the EV Charging Station Enclosure on a solid surface and receives its energy from the electrical energy source or EV power panel. The Motion/Shock Detection Device contains sensors needed to be sure there are no malfunctions such as external force that could cause any sort of harm to people or property. If no malfunction is detected, then the Motion/Shock Detection Device containing the control circuit board causes a signal to be sent to the EV power panel. The presence of the signal maintains the power contactor closed to allow the power flow to the EV (electric vehicle) charging station. If the signal is not received, the power contactor cannot close, and no energy flows.

In another advantageous feature of the present invention, the fail safe operation of the electrical energy source assures that any failure of the energy sourcing system automatically disables all forms of energy release that could cause harm to individuals or property in the system's vicinity. All forms of failure, such as earthquakes, vehicle crash, etc. can be prevented from further damage resulting from exposure of lethal voltages.

In yet another advantageous feature of the present invention, the safety circuit does not connect and if energized, disconnects electrical service in the event that the Motion/Shock Detection Device, pole/post, or supporting structure is exposed to a catastrophic accident, incident, occurrence, or natural disaster occurs involving a utility power distribution system from the grid to sub-transmission/primary distribution/local distribution; and/or an electrical distribution/feed to an electric vehicle charging station, gasoline station pump, propane distribution system, chemical tank farm, petroleum tank farm, fuel farm, or highway/roadway/parking light pole & or lighting system.

Features and advantages of the invention hereof will become more apparent in light of the following detailed description of selected embodiments, as illustrated in the accompanying FIGS. As will be realised, the invention disclosed is capable of modifications in various respects, all without departing from the scope of the invention. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates a block diagram of an electric vehicle charging station, in accordance with one embodiment of the present invention;

FIG. 2 illustrates a block diagram of an electrical energy enclosure, in accordance with one embodiment of the present invention;

FIG. 3 illustrates a schematic diagram of how the signal to the source of electrical energy is impressed on the main power lines when a system utilizing two or three phase electric power is employed, in accordance with one embodiment of the present invention;

FIG. 4 illustrates a block diagram of an electric vehicle charging station, and the associated electrical energy source in accordance with one embodiment of the present invention;

FIG. 5 illustrates a block diagram of an electric vehicle charging station and Motion/Shock Detection Device in accordance with one embodiment of the present invention;

FIG. 6 illustrates a block diagram of how the signal to the source of electrical energy is impressed using a Power Line Communication (PLC) Circuit, on the main power lines when a system utilizing two or three phase electric power is employed, in accordance with one embodiment of the present invention;

FIG. 7 illustrates a block diagram of the PLC Circuit;

FIG. 8 illustrates a block diagram of an internal circuitry of an electric vehicle power panel, in accordance with one embodiment of the present invention; and

FIG. 9 illustrates and internal circuitry diagram of the EV Gyro control board of the sourcing enclosures, in accordance with one embodiment of the present invention.

It will be noted that throughout the appended drawings, like features are identified by like reference numerals.

### DETAILED DESCRIPTION OF THE EMBODIMENTS

Before the present features and working principle of a safety connect system is described, it is to be understood that this invention is not limited to the particular device as described, since it may vary within the specification indicated. Various features of the safety connect system might be provided by introducing variations within the components/subcomponents disclosed herein. It is also to be understood that the terminology used in the description is for the purpose of describing the particular versions or embodiments only and, is not intended to limit the scope of the present invention, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items or, meant to be limited to only the listed item or items.

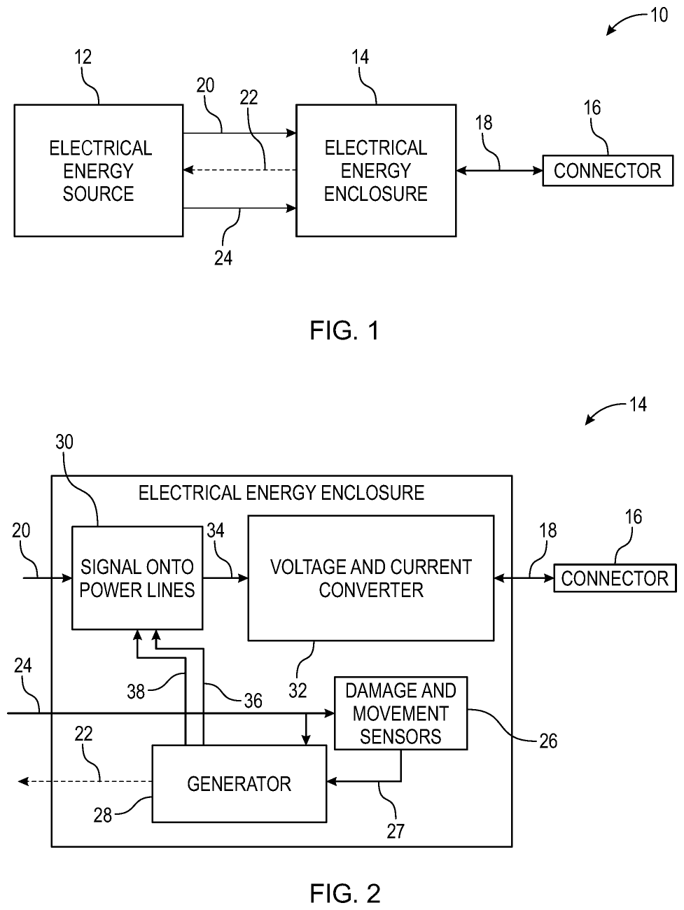

Various features and embodiments of the safety connect system are explained in conjunction with the description of FIGS. 1-9.

FIG. 1 shows a block diagram of an electric vehicle charging station 10 incorporating a safety disconnect system, in accordance with one embodiment of the present invention. Electric vehicle charging station 10 includes an electrical energy source 12 and an electrical energy vending enclosure 14, referred as enclosure 14, hereinafter. Enclosure 14 vends charging energy and connects to connector 16 via a cable 18. Connector 16 allows connection with an electric vehicle battery connector socket. In the present embodiment, cable 18 is shown as going both directions as an electric vehicle sends to enclosure 14 a handshaking exchange of data to assure the proper voltage and current are being supplied. Connector 16 is also a part of an inductive wireless charging system where nothing is directly connected to the electric vehicle. In one example, the handshaking is performed wirelessly, and this allows to prevent the vehicle from moving while it is being charged. Power from electrical energy source 12 is passed through wires 20 to enclosure 14 normally through conduit as electrical energy source 12 and enclosure 14 are separated physically so as to make sure that any damage to enclosure 14 does not damage the electrical energy source 12.

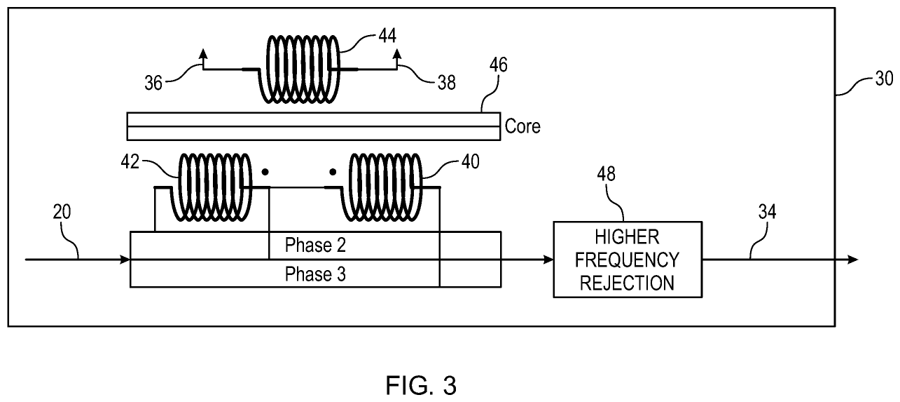

Enclosure 14 sends a signal 22 to electrical energy source 12. Signal 22 assures electrical energy source 12 that it is safe to send said electrical energy to enclosure 14. In FIG. 1, signal 22 is shown in dotted lines to indicate that signal 22 can also be sent wirelessly. In one example, signal 22 is sent using wires 20 by a superimposed high frequency signal that causes a shut down if it is not received, assuring that none of wires 20 have been compromised. Here, all signals must be present for the energy to be allowed to flow, the functionality of which is explained in greater detail using FIGS. 2 and 3.

FIG. 2 shows a block diagram of the inner workings of enclosure 14, in accordance with one embodiment of the present invention. Enclosure 14 presents a line 24. Line 24 positions between electrical energy source 12 and enclosure 14 and carries logic power operate damage and movement sensors 26 or simply sensors 26 and power generator 28 of the safety signal. Sensors 26 and power generator 28 connect via a line 27. The logic power is supplied separately as the system would not be able to start without the safety signal from generator 28 that allows the energy to flow between electric energy source 12 and enclosure 14.

Sensors 26 configure to detect undesired movement of enclosure 14 to vend energy to an energy consuming device (not shown) utilizing one or more detection methods selected from the group consisting of: contact displacement sensors, contact displacement meters, non-contact displacement sensors, non-contact displacement meters, magnetic field, laser, ultrasonic wave, dial gauge, differential transformer, fixed reference transformer, mass-spring transformer, absolute position encoder, cable extension, capacitive, eddy current, fiber optic, Hall Effect, inductive, laser micrometer, linear fixed-reference transducer, mass-spring or seismic transducer, displacement transducers, piezoresistive accelerometers, servo accelerometers, force gages, ground sensing, impedance head, laser Doppler vibrometers (out of plane, scanning, and in-plane, rotational), precision micro-sensors, accelerometer preamplifiers, electro-dynamic transducers, electro-optical displacement, tilt and vibration sensors, inclinometers, tilt sensor, angle sensor, acceleration sensor, shock sensor, vibration sensor, precision micro, rugged package sensors, encoder, linear potentiometer, linear variable differential transformer, magneto resistive, change in position, optical triangulation, photo-electric, position probing, incremental encoder, rotary encoder, photo-junction, solenoid switching, time of flight optical, ultrasonic, variable resistance, limit switch feedback, and wireless position monitors, severed cable detector, severed cable sensor, cover tamper sensor, cover tamper switch, intrusion detector, intrusion sensor, and ground sensing sensors/system.

Signal onto power lines 30 connect to a voltage and current converter 32. Voltage and current converter 32 connects to connector 16 via cable 18, when needed. When voltage and current converter 32 is not needed or the signal is converted at electrical energy source 12, then line 34 is connected directly to connector 16. Energy from electrical energy source 12 passes on wires 20 through signal onto power lines 30, more particularly described in FIG. 3, where the signal to electrical energy source 12 allows the energy to flow is impressed upon wires 20. Line 24 is the logic power for the (damage and movement) sensors 26 and generator 28 for the signal that permits energy transfer. It is to be noted that that the signal to be superimposed on the wires 20 is conducted from generator 28 on lines 36 and 38. If the power on line 24 is interrupted for any reason, then generator 28 is not powered so no signal appears on line 20 or lines 36 and 38 and the power from electrical energy source 12 gets cut or shuts down.

FIG. 3 shows line 20 having two or three wires depending on whether the system operates on two or three phase power. If the system power is only two phase, then Phase 3 wire and secondary winding 40 are omitted. When the total system is in operation as intended, generator 28 places an alternating current signal of a higher frequency on lines 36 and 38 which are connected to a primary winding 44 of transformer 46. Further, secondary winding 42 connects to the Phase 1 and Phase 2 lines and causes the signal from primary winding 44 to be connected between lines 36 and 38 and is sent to electrical energy source 12. If, for any reason, the signal is not received at electrical energy source 12, then electrical energy source 12 is shut down. The same is true if the signal from secondary winding 40 which is connected between the Phase 2 and 3 lines does not arrive at electrical energy source 12. Even though the higher frequency signal from transformer 46 flows both directions on wires 20, it is high enough that it is rejected by a higher frequency rejection circuitry 48 so it does not flow on line 34. It is to be noted that the two secondary winding 40 and 42 are wound with opposite polarity so if only Phase 2 line becomes open the signals to Phase 1 and Phase 3 cancels each other and no signal is received at the electrical energy source and it shuts down.

Further, the present invention discloses a method in which an electrical vehicle charging station enclosure or enclosure that monitors the originally installed position of the enclosure relative to the foundation or attachment on which the enclosure is installed. Here, the enclosure generates a signal that indicates everything is as it should be allowing high voltage power to be fed into the enclosure. Additionally, the same safety system (method) is used on a fuel pump enclosure which is common in a typical gas station or fuel delivery system, to prevent danger from exposed electrical cables in the event of damage or dislodging of the fuel pump enclosure or fuel delivery system.

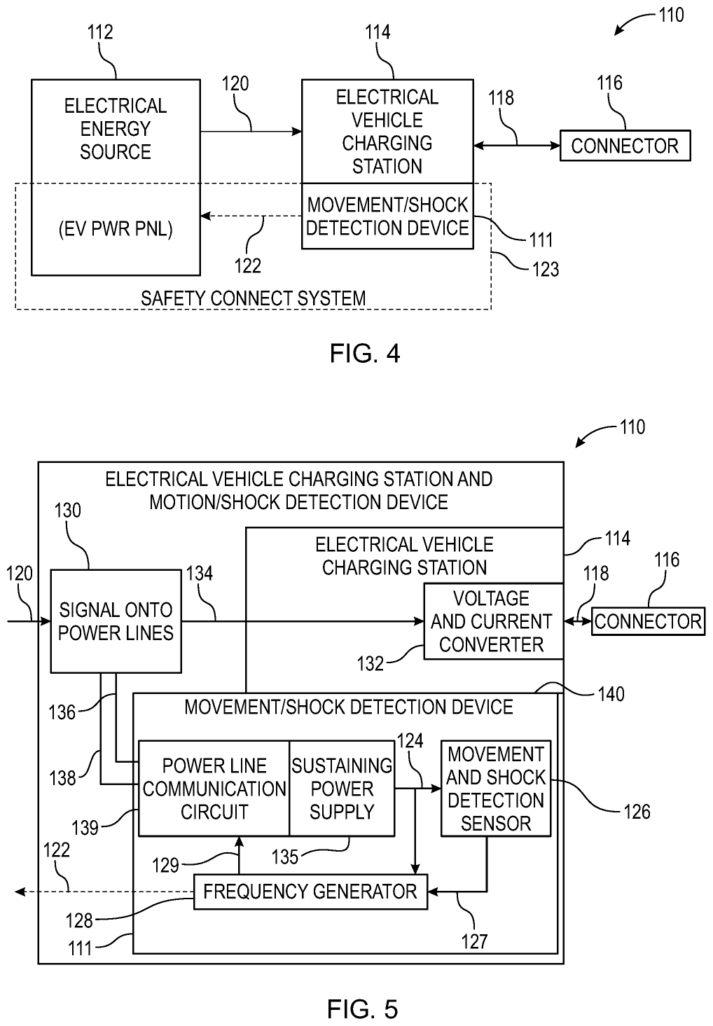

FIG. 4 shows a block diagram of an electric vehicle charging station, electrical energy source and connector 110 to plug into an electric vehicle incorporating a safety connect system 111, in accordance with one embodiment of the present invention. The electric vehicle charging station 110 includes an electrical energy source 112 and an electrical energy vending enclosure 114, referred as enclosure 114, hereinafter. In the present embodiment, enclosure 114 encompasses an electric vehicle (EV) charger and a movement/shock detection device 113. In one implementation, the EV charger is separate from movement/shock detection device 113. Movement/shock detection device 113 connects to the exterior of the EV charger (e.g., at an EV charger cabinet (not shown)). Optionally, the Movement/Shock Detection Device 113 is integrated in the EV charger. Enclosure 114 vends charging energy and connects to a connector 16 via a cable 118. Connector 116 allows connection with an electric vehicle battery connector socket. In the present embodiment, cable 118 is shown as going both directions as an electric vehicle sends to enclosure 114 a handshaking exchange of data to assure the proper voltage and current are being supplied. Connector 116 is also a part of an inductive wireless charging system where nothing is directly connected to the electric vehicle. In one example, the handshaking is performed wirelessly, and this allows to prevent the vehicle from moving while it is being charged. Power from electrical energy source 112 is passed through wires 120 to enclosure 114 normally through conduit as electrical energy source 112 and enclosure 114 are separated physically to assure that any damage to enclosure 114 does not damage the electrical energy source 112.

Movement/Shock Detection Device 113 sends a signal 122 to electrical energy source 112. Signal 122 assures the electrical energy source 112 that it is safe to send said electrical energy to the enclosure 114. In FIG. 4, signal 122 is shown in dotted lines to indicate that signal 122 can also be sent wirelessly. In one example, signal 122 is sent using wires 120 by a superimposed high frequency signal that causes a shut down if it is not received, assuring that none of wires 120 have been compromised. Here, all signals must be present for the energy to be allowed to flow, the functionality of which is explained in greater detail using FIGS. 5, 6 and 7.

FIG. 5 shows a block diagram of the inner workings of enclosure 114 with the added Movement/Shock Detection Device 140, in accordance with one embodiment of the present invention. Signal Onto Power Lines 130 presents a logic power signal on lines 136 and 138 to Power Line Communication Circuit 139. The Power Line Communication Circuit 139 outputs DC Power to Sustaining Power Supply 135. Line 124 delivers power from Sustaining Power Supply 135 to Movement and Shock Detection Sensor (sensor) 126 and Frequency Generator 128. Sensors 126 and Frequency Generator 128 connect via a movement sensor line 127. The logic power is supplied over the power lines 120 even when the main power source is not connected as the system would not be able to start without the safety connect signal 129 from frequency generator 128 that enables the energy to flow between electric energy source 112 and EV charger enclosure and Motion/Shock Detection Device 114.

Sensors 126 configure to detect undesired movement of enclosure 114 to vend energy to an energy consuming device (not shown) utilizing one or more detection methods selected from the group consisting of: contact displacement sensors, contact displacement meters, non-contact displacement sensors, non-contact displacement meters, magnetic field, laser, ultrasonic wave, dial gauge, differential transformer, fixed reference transformer, mass-spring transformer, absolute position encoder, cable extension, capacitive, eddy current, fiber optic, Hall Effect, inductive, laser micrometer, linear fixed-reference transducer, mass-spring or seismic transducer, displacement transducers, piezoresistive accelerometers, servo accelerometers, force gages, ground sensing, impedance head, laser Doppler vibrometers (out of plane, scanning, and in-plane, rotational), precision micro-sensors, accelerometer preamplifiers, electro-dynamic transducers, electro-optical displacement, tilt and vibration sensors, inclinometers, tilt sensor, angle sensor, acceleration sensor, shock sensor, vibration sensor, precision micro, rugged package sensors, encoder, linear potentiometer, linear variable differential transformer, magneto resistive, gyroscope detected movement change in position, optical triangulation, photo-electric, position probing, incremental encoder, rotary encoder, photo-junction, solenoid switching, time of flight optical, ultrasonic, variable resistance, limit switch feedback, and wireless position monitors, severed cable detector, severed cable sensor, cover tamper sensor, cover tamper switch, intrusion detector, intrusion sensor, and ground sensing sensors/system.

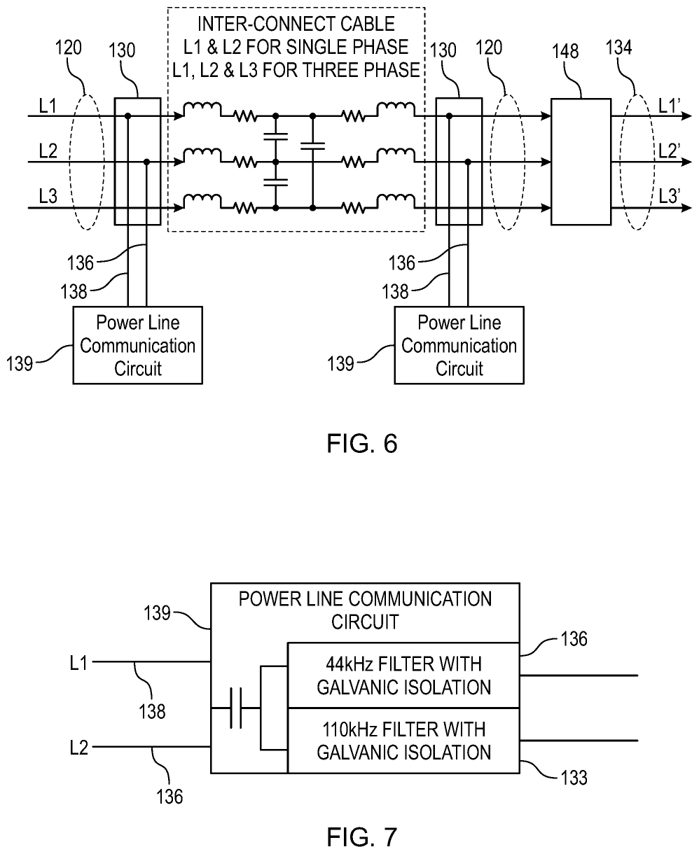

The wires 120 connect to a voltage to Power Line Communication (PLC) 139 at the Signal onto Power Lines 130 and voltage and current converter 132 on line 134. Voltage and current converter 132 connects to connector 116 via cable 118, when needed. When voltage and current converter 132 is not needed or the signal is converted at electrical energy source 112, then line 120 is connected directly to connector 116. Energy from electrical energy source 112 passes on wires 120 more particularly described in FIG. 6, where the signal to electrical energy source 112 allows the energy to flow is impressed upon wires 120. Line 124 is the logic power for the (damage and movement) sensors 126 and generator 128 for the signal that permits energy transfer. The energy on Line 124 is derived from the power line 120 when safety signal is present or alternatively from high frequency power signal on the Signal onto Power Lines 130 when the safety signal is not present. It is to be noted that that the signal to be superimposed on the wires 120 is conducted from generator 128 on lines 136 and 138. If the power on line 124 is interrupted for any reason, then generator 128 is not enabled so no signal appears on line 120 or lines 136 and 138 and the power from electrical energy source 112 is removed or shuts down.

FIG. 6 shows line 120 having two or three wires depending on whether the system operates on two or three phase power. As depicted, line 120 is the interconnect line between the Electrical Energy Source 112 (see FIG. 4) and the Electric Vehicle Charging Station 114 and is shown as a cable with series resistance, series inductance and line to line capacitance. If the system power is only two phases, then Phase 3 is omitted. When the total system is in operation as intended, frequency generator 128 places an alternating current signal of a higher frequency on lines 136 and 138 (FIG. 7) which are connected to the PLC Circuit 139 is sent to electrical energy source 112. If, for any reason, the signal is not received at electrical energy source 112, then electrical energy source 112 is shut down. The PLC Circuit 139 includes two paths for high frequency signal carriers over the low frequency power line 120. The higher frequency (110 kHz) 133 is the safety signal from the enclosure 114 to the Electrical Energy Source 112. The lower frequency (44 kHz)135 is generated at the Electrical Energy Source 112 to provide Sustaining Power 135 to the Movement and Shock Detection Sensor 126 and the Frequency Generator 128 in the Movement/Shock Detection Device 140. Even though the higher frequency signals from the Power Line Communication Circuit 139 flows both directions on wires 120, it is high enough that it is rejected by a higher frequency rejection circuitry 148 so it does not flow on line 134.

Further, the present invention discloses a method in which an electrical vehicle charging station enclosure or enclosure that monitors the originally installed position of the enclosure relative to the foundation or attachment on which the enclosure is installed. Here, the enclosure generates a safety signal that indicates everything is as it should be allowing high voltage power to be fed into the enclosure. Additionally, the same safety connect system (method) is used on a fuel pump enclosure which is common in a typical gas station or fuel delivery system, to prevent danger from exposed electrical cables in the event of damage or dislodging of the fuel pump enclosure or fuel delivery system.

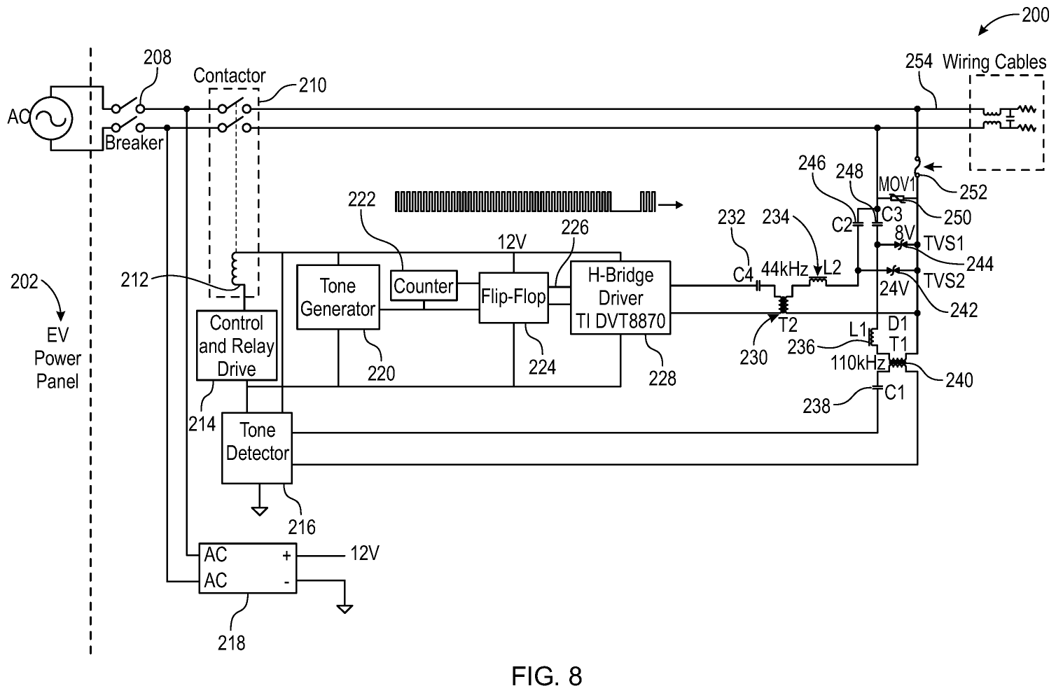

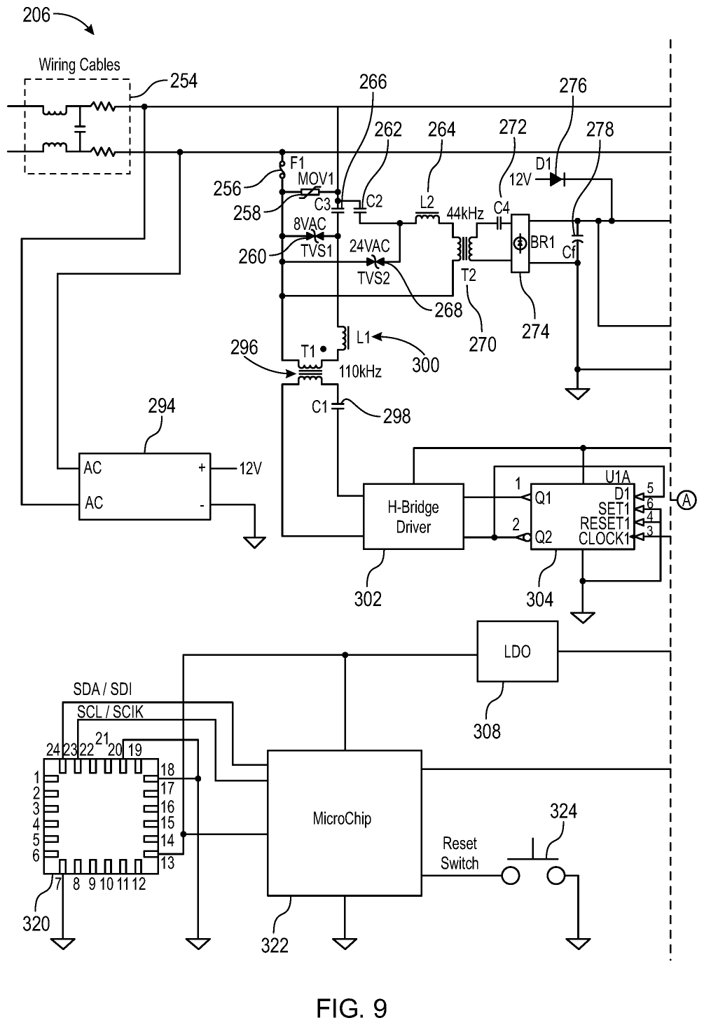

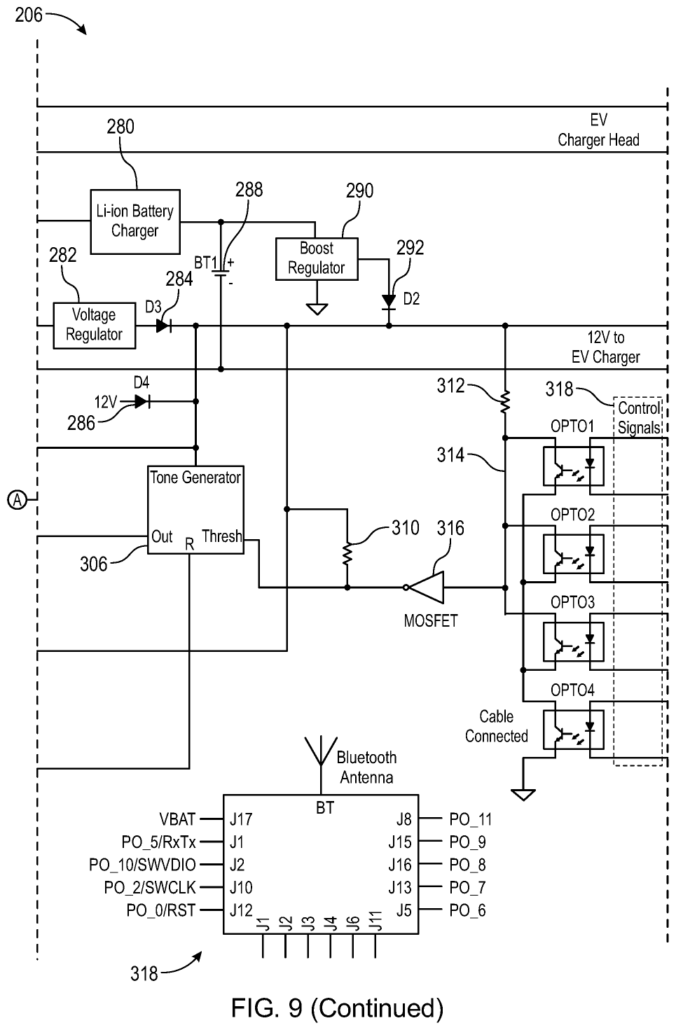

FIGS. 8 and 9 show schematic diagrams of a safety connect system 200, in accordance with one embodiment of the present invention. Safety connect system 200 includes an electrical energy source or electric vehicle (EV) power panel 202 for supplying electrical energy and an enclosure (or electrical sourcing enclosure) 204 for sourcing charging energy to an energy consuming device (not shown) such as an electric vehicle. Enclosure 204 includes an electric vehicle (EV) gyro control board or control circuit board 206 for assuring fail safe operation of the energy sourcing system. In accordance with the present embodiment, a safety signal of about 110 kHz (frequency) flows from enclosure 202 to EV power panel 202 assuring that it is safe to send the electrical energy.

Control board 206 further maintains a record of failures to cut or disconnected power cable/wires from energy sources to the enclosure/control board, in the event that no high frequency low voltage input from the energy source when the safety signal is not being produced by control board 206. This condition arises when no connection exists from the enclosure 204 and the energy source.

FIG. 8 shows a block diagram of the inner workings of EV power panel 202, in accordance with one embodiment of the present invention. EV power panel 202 includes a breaker 208 which is closed by applying AC voltage (208 to 480 VAC) to a contactor 210 input and alternate current (AC) to 12V Direct Current (DC) power Supply (LD20-26B12) 218. Here, contactor 210 remains open until it receives the 110 kHz safety signal from the enclosure 204. When connected, output of power supply 218 is applied to a tone generator 220, a 110 kHz tone detector 216,/2 (divide by 2) Flip-Flop 224, H-Bridge driver 228, and control relay coil 212. In one example, tone detector 216 produces about 88 kHz. The 88 kHz feeds flip-flop 224 to produce 44 kHz that is fed to the input of H-Bridge driver 228.

Further, H-Bridge driver 228 produces 24 VAC p-p drive at 44 kHz across the series circuit of capacitor (C4) 232 and transistor (T2) 230 primary winding. The 44 kHz transformer coupled drive (1×1) is fed into an LC, 44 kHz filter (inductor (L2) 234 and capacitor (C2) 246. EV power panel 202 includes a transient voltage suppressor (TVS) 242 of 24VACp-p, which clamps the voltage at the L2 234, and C2 246 node to limit any damage from 208 to 480 VAC voltage. Values of L2 234 and C2 246 result in a low impedance path for the 24 VAC p-p AC voltage at 44 kHz frequency and a very high impedance to the 60 Hz power voltage. The 44 kHz signal is imposed on the dry power line at a 24 VAC p-p (peak to peak) level to supply charging energy to the EV gyro control board 206, more particularly described in FIG. 9. The 44 kHz signal is interrupted by ⅛ counter 222 for 125 uS, every 875 uS to assure the detection of the 110 kHz safety signal if present on the power line. The output from ⅛ counter 222 drives the Flip Flop input low for ⅛ of the time (77 pulses high and 11 pulses low). At 88 kHz pulse rate, the input to Flip-Flop 224 is high for 77 pulses (⅞ of the period) and low for 11 pulses (⅛ of the period) to produce a 44 kHz signal 226 into H Bridge driver 302. This interruption assures that the 110 kHz safety tone is detected with no interference from the 44 kHz signal 226 superimposed on the 60 Hz power line.

EV power panel 202 includes a resonant (LC) circuit formed by L1 236 and C3 248 that rejects the 44 kHz signal, but provides a low impedance path to the 110 kHz safety signal. The 2nd and 3rd harmonics of 44 kHz (88 kHz and 132 kHz) are evenly spread at 22 kHz on either side of the 110 kHz to minimize interference from the 44 kHz remote energy source. The 110 kHz safety signal is clamped to 8VACp-p by a TVS1 244. The 8 VAC p-p, 110 kHz safety signal is AC coupled through isolation transformer (T1) 240 (Np:Ns=1:1) and C1 238 to tone detector (110 kHz) 216.

Tone Detector 216 provides a reset to tone generator 220,/2 Flip-Flop 224, and H-Bridge driver 210 by removing the 44 kHz signal from the dry power line. Further, when 110 kHz is present on tone detector 216 input, tone detector 216 outputs a high level drive to control and relay driver 214, causing contactor 210 to close, applying AC voltage of 208 to 480 VAC to power line 254. Here, contactor 210 remains energized while the 110 kHz safety signal is present on the AC power line 254. Further, EV power panel 202 includes a capacitor (MOV1) 250 and a fuse (F1) 252.

FIG. 9 shows a block diagram of EV gyro control board 206, in accordance with one embodiment of the present invention. In idle state i.e., when no AC power source is present, EV gyro control board 206 is powered by the 44 kHz, 24Vp-p energy source present on the AC line 254 when EV power panel 202 is energized (i.e., when breaker 108 is closed).

The energy source of 44 kHz at 24 VAC is coupled through fuse 256, MOV1 258, TVS1 260, capacitor C2 262 to a 24 VAC TVS, TVS2 268 (to clamp 208 to 480 VAC 50 to 60 HZ when present). EV gyro control board 206 includes an LC Resonant circuit tuned to 44 kHz is formed with L2 264 and C2 262. The low impedance path at 44 kHz feeds 24VACp-p through transformer (T2) 270 and is AC coupled through capacitor (C4) 272 to bridge rectifier (BR1) 274 to create approximately 22 VDC unregulated voltage across the filter cap (Cf) 278.

Further, the unregulated voltage presents as the input of the battery charger (IC BQ24120) 280 to provide sustained charge to the Li-Ion coin cell battery (BT1) 288. Further, the unregulated voltage also presents as the input to a DC/DC voltage regulator 282. Further, EV gyro control board 206 includes boost regulator 290 and a diode (D2) 292. In one example, power line 254 connects to power supply 294.

DC/DC regulator 282 converts voltage on Cf 278 to 12 VDC. This 12 VDC output is coupled through diode (D3) 284 to provide operational voltage. Here, the 12 VDC output provides operational voltage to EV gyro control board 206 in the idle state and an EV charger unit to provide operational voltage to support detection of interface devices 314 such as coin feed, credit card reader, or cell phone, etc. Further, the 12 VDC output provides operational voltage to 220 kHz tone generator 306,/2 (divide by 2) Flip-flop 304, H-Bridge driver 302, pullup 310 to the MOSFET switch 316. The 12 VDC output provides operational voltage to 3.3 VDC voltage regulator 308, powering gyro IC (motion detection sensor or motion tracking device) 320, and controller 322.

Here, controller 322 receives control signals from interface devices 314 and feeds up to four (4) opto devices to indicate the start of a charging operation. Each opto deive has a series of current limiting resistors and noise suppression BALUN to minimize the risk of damage to the opto input. The opto isolated outputs are in a wired or wireless configuration pulled to 12 VDC through a pull up resistor 312.

In order to initiate a charging cycle, communication through an optocoupler switch from the EV charger system removes the drive from the MOSFET inverter, resulting in the application of a 12 VDC (high) pulled up through resistor 310 on the threshold pin of the tone generator 306. The high voltage on the threshold pin results in a 220 kHz output from the tone generator 306. The 220 kHz is divided into a 110 kHz square wave by the/2 Flip-Flop 304. The 110 kHz drives the H-Bridge inverter driver 302, feeding a 24 VAC p-p drive into the coupling capacitor (C1) 298 to isolation transformer (T1) 296. The secondary of transformer 296 feeds 110 kHz through inductor (L1) 300 to be Clamped to 8Vp-p by a TVS 260. L1 300 and capacitor (C3) 266 complete a 110 kHz resonant LC filter to couple the 110 kHz signal onto the AC power line 254 (L1 to L2 on AC Power Line).

The detection of the 110 kHz safety signal at the EV power panel 202 circuit causes the power contactor 210 to operate, applying 208 to 480 VAC to the power line 254 and removing the 44 kHz power source from the AC Line (L1-L2) 254. 208 TO 480 VAC on the AC line 254 energizes power module/power supply (LD20-26B12) 288. Power supply 288 provides 12 VDC at 1.67 A (20 W) to power the EV gyro control board 206. The 12 VDC forwards bias diode (D1) 276 to provide input voltage for the Li-Ion battery charger 276 to replace the 22V unregulated source that stops when the 44 kHz source is removed from the AV power line 254. The 12 VDC from power supply 288 forwards bias diode (D4) 286 to provide 12 VDC to EV gyro control board 206 in the idle state and the EV charger unit to provide operational voltage to support detection of interface devices 314. Further, the 12 VDC from power supply 288 forwards bias diode (D4) 286 to provide 12 VDC to tone generator 306,/2 (divide by 2) Flip-flop 304, H-Bridge Driver 302, pullup 310, resistor 312 to a MOSFET switch 316. Furthermore, the 12 VDC from power supply 288 forwards bias diode (D4) 286 to provide 12 VDC to 3.3 VDC voltage regulator 308, powering the gyro IC (motion tracking device) 320, and controller (32-bit MicroChip ATSAMG55) 322.

In order to control the operation, controller 322 initializes when 3.3V power is applied. Controller 322 monitors signals from motion detection sensor 320. In one example, motion detection sensor 320 includes an INV20948 9-Axis MEMS MotionTracking™ Device. Motion detection sensor 320 outputs a level to controller 322 that causes a shutdown of the 110 kHz safety tone.

In case the EV charger station encounters a shock or external force in any axis of a sufficient level to exceed threshold levels preset in motion detection sensor 320, then motion detection sensor 320 transmits a signal to controller 322. In addition to detecting an accelerometer force, motion detection sensor 320 detects a change in position in any of three (3) Axis, permanent or momentary, of enclosure 204 to which it is affixed. Controller 322 responds to a signal from motion detection sensor 320 by applying a reset to the tone generator 306, stopping the 220 kHz square wave to H-Bridge inverter 302, which stops the 110 kHz safety signal being passed to the 208-480 VAC power line. This way, controller 322 shuts down when EV charger station encounters a shock or external force exceeding the threshold levels.

Further, controller 322 halts the detection of the 110 kHz safety signal on the AC power line 254 when the 110 kHz safety signal is stopped by a high level from motion detection sensor 320. Here, contactor 210 on the EV power panel 202 opens, removing 208-480 VAC from the power line 254. 24 VAC at 44 kHz couples to the power line 254. The 12 VDC source couples through either diode (D4) 286 to the input of the battery charger (IC BQ24120) 280 to provide sustained charge to the Li-Ion coin cell battery 288.

Once a fault/shutdown occurs, the EV gyro control board is reset to return a charging function. Further, the fault/shutdown condition is manually reviewed/investigated by on-site investigation personnel. If such investigation determines there is minimal or no damage to the EV charger system, then the EV Charger is reset to return to normal operation by pressing and releasing reset switch 324 on EV gyro control board 206 or by initiating a reset through a communication device 318 built into the EV gyro control board 206. In one example, communication device 318 includes a Bluetooth device.

In one example, EV gyro control board 206 incorporates communication device 318 to set the location detection constant parameters in motion detection sensor 320. Further, communication device 318 allows a remote Bluetooth reset of the EV gyro control board 206. Further, communication device 318 provides a communication to read the parameter settings in the circuit of motion detection sensor 320. Furthermore, communication device 318 provides an application for mobile phone/electronic devices to communicate and change or reset motion detection sensor 320. Optionally, communication device 318 provides a reset drive to the 220 kHz tone generator 306 to stop the 110 kHz safety tone.

It should be understood resetting EV gyro control board 206 results in updating of the location detection constant parameters to be latched into motion detection sensor 320 based on the current position of the EV gyro control board 206.

From the above, it is clear that the presently disclosed electrical vehicle charging station enclosure or enclosure monitors the originally installed position of the enclosure relative to the foundation or attachment on which the enclosure is installed. Here, the enclosure generates a signal that indicates everything is as it should be allowing high voltage power to be fed into the enclosure. Additionally, the same safety system (method) is used on a fuel pump enclosure which is common in a typical gas station or fuel delivery system, to prevent danger from exposed electrical cables in the event of damage or dislodging of the fuel pump enclosure or fuel delivery system.

In the above description, numerous specific details are set forth such as examples of some embodiments, specific components, devices, methods, in order to provide a thorough understanding of embodiments of the present disclosure. It will be apparent to a person of ordinary skill in the art that these specific details need not be employed, and should not be construed to limit the scope of the disclosure.

In the development of any actual implementation, numerous implementation-specific decisions must be made to achieve the developer's specific goals, such as compliance with system-related and business-related constraints. Such a development effort might be complex and time consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. The claimed invention set forth in the claims may not intended to be limited to the embodiments shown herein, but is to be accorded the widest scope consistent with the principles and novel features disclosed herein. It is contemplated that additional embodiments are within the spirit and true scope of the disclosed invention.

What is claimed is:

1. An energy sourcing system, comprising:
an electrical energy source connected to an enclosure, said enclosure sources energy from said electrical energy source and supplies to an energy consuming device, wherein said enclosure comprises a control circuit board,
wherein said control circuit board comprises a motion detection sensor, wherein said motion detection sensor detects a change in position of said enclosure,
wherein said control circuit board repeatedly sends a safety signal to said electrical energy source when said motion detection sensor detects the change in position of said enclosure is below a preset threshold, and
wherein said electrical energy source does not allow the energy to flow to said enclosure when said electrical energy source does not receive the safety signal from said enclosure.

2. The energy sourcing system of claim 1, further comprises a controller, wherein said controller resets or shuts down said electrical energy source when said motion detection sensor detects the change in position of said enclosure exceeds the preset threshold.

3. The energy sourcing system of claim 1, further comprises a controller, wherein said controller resets or shuts down said electrical energy source when said motion detection sensor detects through a hard connection between said enclosure and an energy consuming device, thereby detecting that said hard connection exists prior to said control circuit board sending said safety signal to an energy source.

4. The energy sourcing system of claim 2, wherein said controller resets or shuts down said electrical energy source by stopping the safety signal sent from said enclosure to said electrical energy source.

5. The energy sourcing system of claim 4, wherein said control circuit board comprises a communication device, and wherein said communication device allows for remote resetting or shutting down of said motion detection sensor.

6. The energy sourcing system of claim 1, wherein said enclosure and said energy consuming device are located at a distance from said electrical energy source such that damage caused to said enclosure does not affect said electrical energy source.

7. The energy sourcing system of claim 1, wherein said energy consuming device and said electrical energy source are contained in a single device.

8. The energy sourcing system of claim 1, wherein the safety signal sent from said enclosure to said electrical energy source is in the form of a direct wired connection between said electrical energy source and said enclosure.

9. The energy sourcing system of claim 1, wherein the safety signal sent from said enclosure to said electrical energy source is in the form of a wireless encoded connection between said electrical energy source and said enclosure.

10. The energy sourcing system of claim 1, wherein said electrical energy source sends a high frequency high voltage signal to said enclosure when said motion detection sensor detects the change in position of said enclosure is below the preset threshold.

11. The energy sourcing system of claim 1, wherein the safety signal derives from a gyroscope enabled movement detector and is transmitted simultaneously over both power wires delivering the energy to said enclosure from said electrical energy source in a single phase system or one signal between phase 1 & 2 and a second signal between phase 2 & 3 on a three phase system.

12. The energy sourcing system of claim 1, wherein said safety signal is conducted from a generator, and wherein when the power is interrupted, said generator is not enabled causing the safety signal to not appear and shutting the power from said electrical energy source.

13. An energy sourcing system, comprising:
an electrical energy source connected to an enclosure, said enclosure sources energy from said electrical energy source and supplies to an energy consuming device,
wherein said enclosure sends a safety signal to said electrical energy source when no malfunction is detected, and said electrical energy source supplies a high frequency, high voltage signal to said enclosure, and
wherein when said enclosure does not send the safety signal to said electrical energy source, said electrical energy source supplies a lower frequency low voltage signal to said enclosure using a gyroscope-based movement and position detection device.

14. The energy sourcing system of claim 13, wherein said enclosure detects malfunction by undesired movement of said enclosure utilizing one or more detection methods selected from the group consisting of: contact displacement sensors, contact displacement meters, non-contact displacement sensors, non-contact displacement meters, magnetic field, laser, ultrasonic wave, dial gauge, differential transformer, fixed reference transformer, mass-spring transformer, absolute position encoder, cable extension, capacitive, eddy current, fiber optic, Hall Effect, inductive, laser micrometer, linear fixed-reference transducer, mass-spring or seismic transducer, displacement transducers, piezoresistive accelerometers, servo accelerometers, force gages, ground sensing, impedance head, laser Doppler vibrometers, precision micro-sensors, accelerometer preamplifiers, electro-dynamic transducers, electro-optical displacement, tilt and vibration sensors, inclinometers, tilt sensor, angle sensor, acceleration sensor, shock sensor, vibration sensor, precision micro, rugged package sensors, encoder, linear potentiometer, linear variable differential transformer, magneto resistive, optical triangulation, photo-electric, position probing, incremental encoder, rotary encoder, photo-junction, solenoid switching, time of flight optical, ultrasonic, variable resistance, limit switch feedback, and wireless position monitors, severed cable detector, severed cable sensor, cover tamper sensor, cover tamper switch, intrusion detector, intrusion sensor, and ground sensing sensors/system.

15. The energy sourcing system of claim 13, wherein said enclosure comprises a communication device, and wherein said communication device transmits information corresponding to the malfunction.

16. The energy sourcing system of claim 13, wherein said enclosure and said energy consuming device are located at a distance from said electrical energy source such that damage caused to said enclosure does not affect said electrical energy source.

17. The energy sourcing system of claim 13, wherein said energy consuming device and said electrical energy source are contained in a single device.

18. The energy sourcing system of claim 13, wherein the safety signal sent from said enclosure to said electrical energy source is in the form of a direct wired connection between said electrical energy source and said enclosure.

19. The energy sourcing system of claim 13, wherein the safety signal sent from said enclosure to said electrical energy source is in the form of a wireless encoded connection between said electrical energy source and said enclosure.

20. The energy sourcing system of claim 13, wherein said electrical energy source sends a high frequency voltage signal over the interconnecting power line to said enclosure when said enclosure sensor detects the change indicating a malfunction using a gyroscope enabled movement detector.

21. The energy sourcing system of claim 13, wherein said safety signal is conducted from a generator, and wherein when the power is interrupted, said generator is not enabled causing the safety signal to not appear and shutting the power from said electrical energy source.

22. The energy sourcing system of claim 13, further comprising a controller, wherein said controller resets or shuts down said electrical energy source when said motion detection sensor detects through a hard connection between said enclosure and an energy consuming device, thereby detecting that said hard connection exists prior to said control circuit board sending said safety signal to an energy source.

23. A method of providing an energy sourcing system, said method comprising the steps of:
connecting an electrical energy source to an enclosure;
supplying energy from said electrical energy source to an energy consuming device positioned in said enclosure;
providing a motion detection sensor within said enclosure for detecting a change in position of said enclosure;
sending a safety signal repeatedly to said electrical energy source when said motion detection sensor detects the
change in position of said enclosure is below a preset threshold; and
stopping flow of the energy from said electrical energy source to said enclosure when said electrical energy source does not receive the safety signal from said enclosure.

24. The method of claim 23, further comprising resetting or shutting down said electrical energy source when said electrical energy source does not receive the safety signal from said enclosure.
